(19) United States
(12) Patent Application Publication
(10) Pub. No.: US 2010/0063701 A1
(43) Pub. Date: Mar. 11, 2010

(54) BRAKE BASED VISCOUS COUPLING ALTERNATIVE VEHICLE DIFFERENTIAL

(75) Inventors: Michael E. Caporali, Endicott, NY (US); William C. Craig, Endicott, NY (US); Richard S. Stevens, Endicott, NY (US)

Correspondence Address: BURNS & LEVINSON, LLP, 125 SUMMER STREET, BOSTON, MA, 02110, US

(73) Assignee: LOCKHEED MARTIN CORPORATION, Bethesda, MD (US)

(21) Appl. No.: 12/206,992

(22) Filed: Sep. 9, 2008

(51) Int. Cl. F16H 48/22; G06F 19/00

(52) U.S. Cl. 701/69; 74/650

(57) ABSTRACT

A vehicle and a method for mechanical decoupling of front and rear wheels and left and right wheels of a vehicle by mechanically decoupling the left and right wheels, while controlling the braking to maintain proper wheel speed during vehicle maneuvers.

### FIELD OF THE INVENTION

This invention relates generally to the automotive art, and, more particularly to a brake based viscous coupling.

### BACKGROUND OF THE INVENTION

U.S. Pat. No. 4,337,840 discloses an all-wheel drive device for all-terrain vehicles using a conventional differential for the wheels of the rear axle and separate devices for each individual front steerable wheel.

U.S. Pat. No. 4,650,028 discloses a viscous fluid rear axle coupling apparatus for a front engine vehicle having a front transaxle drivingly inter connected to its front pair of wheels.

U.S. Pat. No. 4,919,006 discloses a limited slip viscous differential in which the housing is gearingly connected with the drive axle and rotates therewith.

U.S. Pat. No. 4,940,123 discloses a viscous coupling capable of preventing decrease in torque obtained by the shear force.

U.S. Pat. No. 4,989,476 discloses a torque transmitting device for transmitting torque by utilizing the viscosity of a fluid.

U.S. Pat. No. 5,079,708 discloses a mechanism for improving the cornering capability of a read vehicle which apportions torques applied to the wheels.

U.S. Pat. No. 5,279,402 discloses a freewheeling device where the outer freewheeling component and the inner freewheeling component are connected in the main torque transmitting direction by locking members.

U.S. Pat. No. 5,314,039 discloses a drive assembly for a four wheel drive vehicle which, during forward driving

U.S. Pat. No. 5,474,369 discloses a braking force control system capable of independently controlling braking forces of front wheel brakes and rear wheel brakes.

U.S. Pat. No. 6,481,806 discloses a vehicle brake control providing an understeer correction through an increase in differential brake pressure.

U.S. Pat. No. 7,165,644 discloses a method of controlling an automotive vehicle having a turning radius which includes determining a hand wheel torque and applying brake-steer as a function of hand wheel torque.

U.S. Published Patent Application 2001/0006137 discloses a viscous coupling having two rotatable parts in the form of a hub and a housing for the transmission of torque between the rotatable parts caused by a positive speed differential between the rotatable parts.

U.S. Published Patent Application No. 2005/0240332 discloses correction of a target vehicle path in accordance with the environment surrounding the vehicle during parking.

U.S. Published Patent Application No. 2006/0124374 discloses apparatus for controlling the driving force of a vehicle using brakes to limit a differential operation.

Conventional vehicle drive lines use a differential to control torque distribution to the drive wheels. On all wheel drive vehicles this situation is compounded by the fact that there are most likely three differentials. One for the front and rear axles, and one for the drive line at the transfer case. These differential packages are large and heavy. This takes up valuable space within the chassis for packaging of components and adds to vehicle weight which can affect vehicle performance, transportability and fuel efficiency.

### SUMMARY OF THE PRESENT INVENTION

Most vehicles today have antilock brakes which implies that wheel speed can be monitored at each individual wheel end. Additionally, with the advent of stability and traction control systems, other sensors have been designed into vehicles to allow the brakes to perform vehicle control functions in a fashion transparent to the driver. Using inertial sensors, wheel speed sensors, monitoring steering wheel angle, etc. algorithms have been developed that allow digital control systems to effectively control the brakes at each individual wheel end and distribute torque to provide better traction and stability.

The present invention builds on that technology as a means of eliminating the differential gear set front and rear and replacing them with a simple bevel gear. The center differential is eliminated in total. By using the brakes in combination with the existing sensors it is possible to control wheel speed at each individual wheel end. A method to mechanically decouple wheels on opposite sides of the drive axles both front and rear is used. The present invention provides the use of a viscous coupling on the drive axle (or between half shafts) to facilitate this mechanical decoupling. With a viscous coupling it is possible to use the brakes, via a set of control algorithms and various sensors, to change wheel speed as a vehicle executes a turn and the inner wheels need to rotate at a slower speed. Since when turning the relative speed difference is rather small, the viscous coupling allows a relative speed difference side to side across the vehicle and eliminates the need for the differential gear set. In conditions of low traction, when one or the other wheel is in a better or worse tractive condition, the wheel speed difference is considerably greater. In this situation the viscous coupling performs as designed and more rigidly couple the wheel and force torque distribution to the wheel in the better tractive condition.

The present invention provides limited slip differential without the undesirable characteristics exhibited by conventional clutch based limited slip differentials when in tight turns. By implementing this design concept packaging space requirement is reduced and weight is saved. The present invention provides a means of mechanical decoupling of the drive axles from left to right, and the use of brake based control to maintain proper wheel speed during vehicle maneuvers.

The present invention takes advantage of systems already designed into the vehicle. It is also smaller and lighter than other approaches, which has positive impacts on other elements of the vehicle design.

Thus, viscous coupling on the drive axle (or between half shafts) is provided to facilitate mechanical decoupling. The present invention uses brakes, via a set of control algorithms and various sensors to change wheel speed as a vehicle executes a turn and the inner wheels need to rotate at a slower speed.

The present invention together with the above and other advantages may best be understood from the following detailed description of the embodiments of the invention illustrated in the drawings, wherein:

### BRIEF DESCRIPTION OF THE DRAWINGS

FIG. 1 is a diagrammatic view of the drive train for a vehicle using the present invention.

FIG. 2 is an isometric diagrammatic view of one type of viscous coupling.

FIG. 3 is a diagrammatic cross-sectional view of another type of viscous coupling.

FIG. 4 is a diagrammatic view of the drive train for a prior art configuration with center, front and rear differentials.

FIG. 5 is a diagrammatic view of the structure and process of the present invention

FIG. 6 provides a diagrammatic view of a vehicle.

### DETAILED DESCRIPTION OF PREFERRED EMBODIMENTS

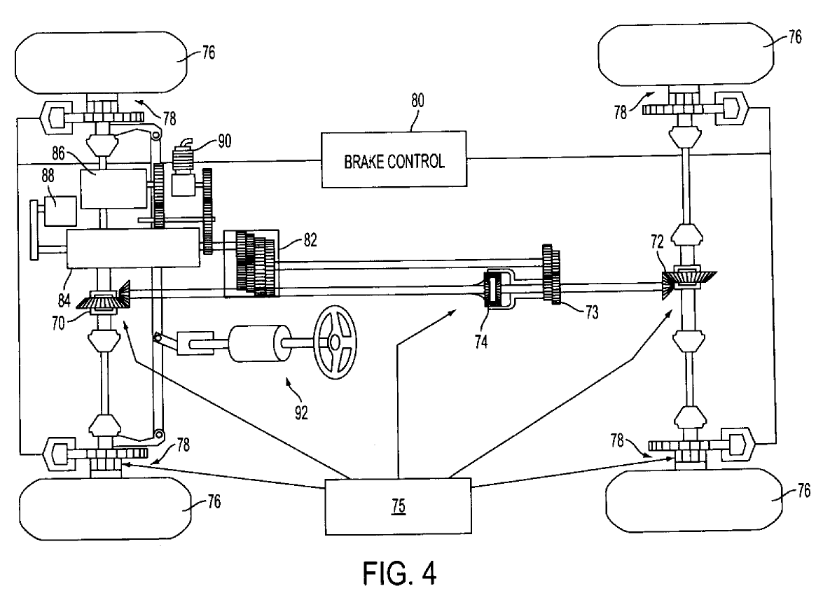

A prior art arrangement is shown in FIG. 4 which shows, as indicated by reference numeral 75, an all wheel drive layout with three differentials and gear reduction hubs. This figure shows an arrangement in which the four wheels are provided with a front differential 70, a rear differential 72 and a center differential 74 with a 2 speed transfer case 73. The wheels 76 are provided with a hubs 78 having planetary gear reduction and it is an all wheel drive arrangement. There is a brake control system 80 and an automatic transmission 82. There is an IC engine 84, a hydraulic pump 86 and an alternator 88. Also there is an air compressor 90 and a steering assembly 92.

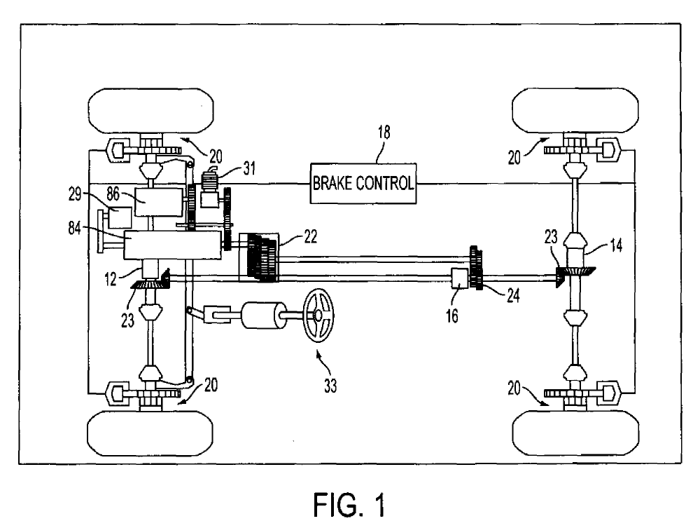

The present invention is shown in FIG. 1 which shows an arrangement in which the drive axles are modified with three viscous couplings, which include a front viscous coupling 12, a rear viscous coupling 14 and a center viscous coupling 16, which may have a 2 speed transfer case 24 if desired or needed, and a brake based differential control 18. There is an IC engine 84, a hydraulic pump 86, an alternator 29, an air compressor 31 and a steering assembly 33. There are gear reduction hubs 20 with planetary gears and a transmission 22. There are bevel gears 23.

The present invention provides alternative means of torque distribution such that the front and rear differentials can be reduced to a simple bevel gear set, if desired, and the center differential can be eliminated all together.

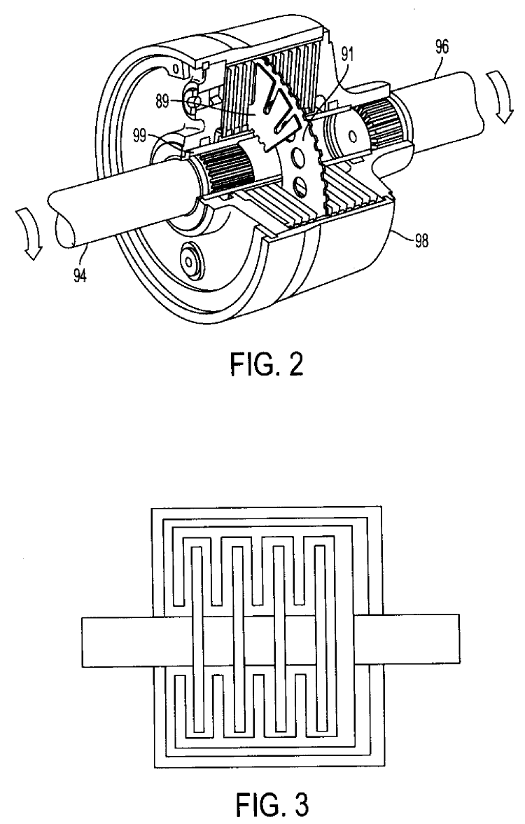

FIGS. 2 and 3 show two different types of viscous couplings which may be used in the present invention. FIG. 2 has a pinion shaft 94, and a flange shaft 96 as well as a coupling housing 98, a hub 99, as well as inner plates 89 and outer plates 91.

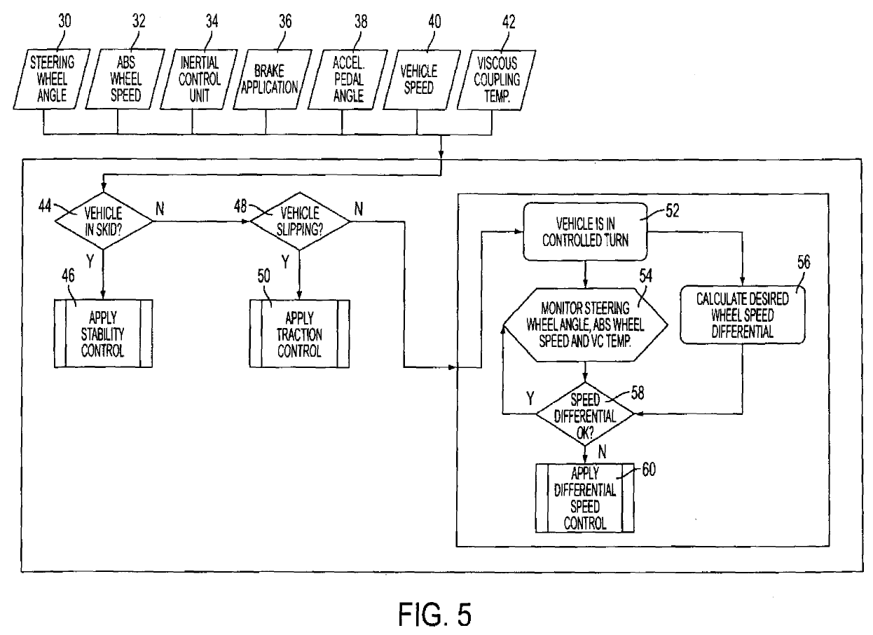

FIG. 5 is a diagram showing the differential control process which has been added to the overall stability/traction control system. This process uses the existing data for wheel speed, steering wheel angle, and other vehicle data to determine whether the vehicle is in a controlled/intended turn. If desired the temperature of the viscous coupling can be monitored to determine whether it is beginning to attempt a torque shift to the inner (slow) wheel. Viscous couplings by themselves do not need any sensory data to operate. They contain interleaved discs which are coupled to each other through the use of a variable viscosity fluid. As the speed differential increases between the interleaved discs the fluid heats up which in turn increases the fluid shear strength. This increase in shear strength causes more power to shift to the slower spinning disc set which is presumably coupled to the wheel with better traction. In this manner torque is shifted from the low traction wheel to the high traction wheel.

This torque shift could be undesirable in a controlled turn event where speed differential is necessary. In most cases where turning is of short duration, and at relatively low speed, the viscous coupling would normally work properly with no external intervention. However, in certain long duration, higher speed, events this could cause overheating in the coupling and begin an unwanted torque transfer.

The terms “long duration, higher speed events” and “short duration” are used to differentiate between a fairly low end event such as for example a turn from a stop sign where the speed would be less than 15 mph and the duration 2 or 3 seconds, versus a more significant event like the exit ramp type event in which case the speed could be grater than 25 mph and could last 20 seconds or more. It is contemplated that over 20 mph and over 5 seconds would begin to trigger the viscous coupling and some action may have to be taken to intervene based on this estimate.

This could be thought of as the “exit ramp” scenario; a fairly long and high speed event. By using the brakes to control the speed of the inner wheel the shift of torque could be prevented and allow control to be maintained throughout the turn.

In the flow chart of FIG. 5, the data for steering wheel angle, ABS wheel speed and the inertial sensors can be used to determine that a controlled turn event is initiated. The existing traction/stability control algorithms within the vehicle can already readily determine that the vehicle is under control and in a consistent traction event.

The process has information points and process steps as follows. The Steering Wheel Angle 30, ABS Wheel Speed 32, Inertial Control Unit 34, Brake Application 36, Acceleration Pedal Angle 38, Vehicle Speed 40, and Viscous Coupling Temperature 42. The information is fed to step 44 which determines from this information whether the vehicle is in a skid. If it is in a skid then in step 46 stability control is applied. If it is not in a skid the information is fed to step 48 to determine whether the vehicle is slipping. If it is slipping then in step 50 traction control is applied. If it is not slipping, then the information is fed to step 52 which determines whether the vehicle is in a controlled turn. At the same time the information from step 52 is fed to step 54 which monitors steering wheel angle, ABS wheel speed and VC temperature, as well as being fed to step 56 where there is calculation of the desired wheel speed differential. The output from steps 52 and 56 are fed into step 58 which determines whether the speed differential is correct. If it is this information is fed back to step 54 and if it is not the process proceeds to step 60 where differential speed control is applied.

Once the control system determines that the vehicle is under control it can then use the steering wheel angle to determine the radius of the turn and therefore the desired wheel speed differential needed across the vehicle. The exact differential would be a function of the vehicle's design, specifically the track width. Once that differential is determined the ABS sensors can monitor wheel speed and determine if it is within an acceptable range. If not the brakes could be applied to the inner wheel to bring it to the proper speed.

In another embodiment where the vehicle is being used off-road, there may be frequent speed differentials across the vehicle due to varying traction. In such a case, when executing a controlled turn the viscous coupling may be quite warm. The temperature data could cause the control system to apply brakes as needed to control crosscar wheel speed and keep the vehicle under control.

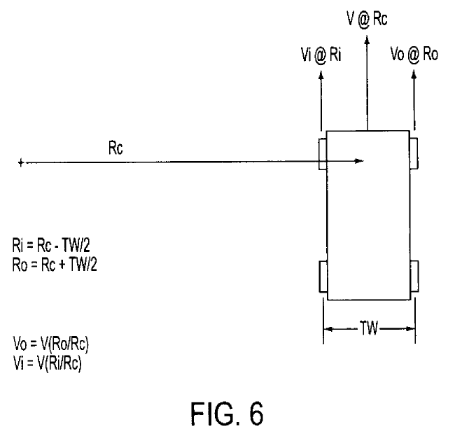

The actual wheel speed differential is a function of the vehicle's design and the turn radius. In a simple form the situation can be viewed as shown in FIG. 6. In this case the value of V corresponds to the vehicle's overall speed and TW corresponds to the track width of the vehicle. Based on the vehicle design one can determine the turning radii for the inner and outer wheels. The turn radius for the inside wheel is Ri and the turn radius for the outside wheel is Ro.

In a simple example, assume there is a vehicle entering a 100 ft radius turn at 30 mph. Further assume this vehicle has a 6 ft track width. Using the equations shown in FIG. 6, one can see that the inner wheel needs to travel at an effective velocity of 29.1 mph, while the outer wheel needs to travel at 30.9 mph. [Ri=100−3=97, while Ro=100+3 =103. Vi=30 times 97/100=291.1, while Vo=30 times 103/100 =30.9] The entire vehicle is traveling as one piece, but the shorter inner radius means that the tire is covering less ground per unit of time than the outer wheel. This corresponds to a slower RPM for the inner wheel. The ABS sensor can monitor this and apply brakes if commanded to do so. In this simple example, the inner wheel would need to maintain a relative speed that is 96.1% of the outer wheel's speed.

The present invention may provide a replacement of the differential gear set now used in vehicles with a viscous coupling to reduce package size and weight. The use of the vehicle's brakes can be incorporated into this embodiment to insure that proper wheel speed differential is maintained when the vehicle is executing a controlled/commanded turn.

The present invention takes advantage of systems already designed into the vehicle. It is also smaller and lighter than other approaches which has positive impacts on other elements of the vehicle design.

The present invention can be used with today's vehicles, most of which have antilock brakes so that wheel speed can be monitored at each individual wheel end. Additionally, with the use of stability and traction control systems, other sensors can be designed into vehicles to allow the brakes to perform vehicle control functions in a fashion transparent to the driver. Using inertial sensors, wheel speed sensors, monitoring steering wheel angle, etc. algorithms have been developed that allow digital control systems to effectively control the brakes at each individual wheel end and distribute torque to provide better traction and stability.

The viscous couplers are used to assist in controlling the torque side to side on the vehicle together with the brake control system.

By using the brakes in combination with the existing sensors it is possible to control wheel speed at each individual wheel end. The present invention provides an arrangement which mechanically decouples wheels on opposite sides of the drive axles both front and rear. The present invention provides the use of a viscous coupling on the drive axle (or between half shafts) to facilitate this mechanical decoupling. With a viscous coupling it is then possible to use the brakes via a set of control algorithms and various sensors to change wheel speed as a vehicle executes a turn and the inner wheels need to rotate at a slower speed. Given that when turning the relative speed difference is rather small, the viscous coupling would allow a relative speed difference side to side across the vehicle and eliminate the need for the differential gear set. In conditions of low traction when one or the other wheel is in a better or worse tractive condition the wheel speed difference is considerably greater. In this situation the viscous coupling would perform as designed and more rigidly couple the wheel and force torque distribution to the wheel in the better tractive condition. To some extent this invention would behave in the same manner as a conventional limited slip differential but without the undesirable characteristics exhibited by conventional clutch based limited slip differentials when in tight turns. By implementing this design concept packaging space requirement would be reduced and weight could be saved. There are most likely other means of providing the mechanical decoupling which could be used in place of the viscous coupling. The key to the invention is a means of mechanical decoupling of the drive axles from left to right, and the use of brake based control to maintain proper wheel speed during vehicle maneuvers.

It is mechanically much simpler and reduces failure potential. It takes advantage of systems already designed into the vehicle. It is also smaller and lighter than other approaches which has positive impacts on other elements of the vehicle design.

Thus, viscous coupling on the drive axle (or between half shafts) is provided to facilitate mechanical decoupling. The present invention uses brakes, via a set of control algorithms and various sensors to change wheel speed as a vehicle executes a turn and the inner wheels need to rotate at a slower speed.

This problem has existed since the origin of automotive design and various solution have been tried, including conventional differentials, and clutch based “differentials” which transfer torque via clutch packs in the differential. Additionally, viscous coupling devices have been used to replace or augment the center differential in “all wheel drive” vehicles. In this scenario the coupler is used to transfer torque front to rear, or vice-versa, as the main drive axle slips, and is not really functioning to control torque side to side on a vehicle. Other solutions attempted include the use of electric wheel motors which drive each wheel independently. In this case there is not mechanical coupling between the engine and wheel, it is all done electrically with the engine providing electrical power only by driving a generator. The disadvantage to this system is the added wheel end weight which is “unsprung”, and it also puts electrical equipment at a low level on the vehicle which has packaging implications, especially in the military vehicle market where deep water fording is a requirement.

This problem has existed since the origin of automotive design. The problem has been solved in many ways including conventional differentials, and clutch based “differentials” which transfer torque via clutch packs in the differential. Additionally, viscous coupling devices have been used to replace or augment the center differential in “all wheel drive” vehicles. In this scenario the coupler is used to transfer torque front to rear, or vice-versa, as the man drive axle slips, and is not really functioning to control torque side to side on a vehicle. Other solutions include the use of electric wheel motors which drive each wheel independently. In this case there is not mechanical coupling between the engine and wheel, it is all done electrically with the engine providing electrical power only by driving a generator. The disadvantage to this system is the added wheel end weight which is “unsprung”, and it also puts electrical equipment at a low level on the vehicle which has packaging implications, especially in the military vehicle market where deep water fording is a requirement.

It is to be understood that the above-described embodiments are simply illustrative of the principles of the invention. Various and other modifications and changes may be made by those skilled in the art which will embody the principles of the invention and fall within the spirit and scope thereof.

1. In a vehicle having front and rear wheels and left and right wheels, the improvement comprising a mechanical decoupling assembly for the drive axles from left to right and a brake based control assembly cooperating therewith to maintain proper wheel speed during vehicle maneuvers.

2. The improvement of claim 1 wherein the mechanical decoupling assembly includes a viscous coupling.

3. The improvement of claim 2 wherein the mechanical decoupling and the brake based control assembly change the speed of the wheel as a vehicle executes a turn whereby the inner wheels during such turn rotate at a slower speed than the outer wheels.

4. The improvement of claim 3 further comprising an arrangement for determining whether the desired wheel speed differential is acceptable and apply differential speed control if it is not acceptable.

5. The improvement of claim 4 wherein the mechanical decoupling and the brake based control assembly apply the differential speed control.

6. The improvement of claim 5 wherein the mechanical decoupling assembly includes a front viscous coupling, a rear viscous coupling and a center viscous coupling.

7. The improvement of claim 6 further comprising gear reduction hubs at each wheel.

8. The improvement of claim 1 further comprising a data information collection arrangement for providing steering wheel angle, ABS wheel speed, inertial information, brake application information, acceleration pedal angel, vehicle speed and viscous coupling temperature for determining whether the vehicle is in a skid.

9. A method for mechanical decoupling of front and rear wheels and left and right wheels of a vehicle, comprising the steps of:
a. mechanically decoupling of the left and right wheels, while
b. controlling the braking to maintain proper wheel speed during vehicle maneuvers.

10. The method of claim 9 wherein the mechanical decoupling step is carried out using a viscous coupling and controlling the brakes is carried out using a set of control algorithms.

11. The method of claim 10 wherein during a turn the speeds of the wheels are changed as the vehicle executes a turn so that the inner wheels during such turn rotate at a slower speed than the outer wheels.

12. The method of claim 11 further comprising the step of determining whether the desired wheel speed differential is acceptable and applying differential speed control if it is not acceptable.

13. The method of claim 12 wherein the differential speed control is provided by the mechanical decoupling of the left and right wheels and controlling the braking.

14. The method of claim 11 further comprising the step of determining whether the vehicle is in a skid, and if it is, stability control is applied.

15. The method of claim 14 further comprising applying traction control if the vehicle in not in a skid but is slipping.

16. The method of claim 15 further comprising, in the event the vehicle is not is a skid and is not slipping monitoring steering wheel angle, ABS wheel speed and VC temperature and calculating the desired wheel speed differential.

17. The method of claim 16 further comprising determining whether the speed differential is correct and if not applying differential speed control.
